(19) United States
(12) Patent Application Publication
(10) Pub. No.: US 2010/0142428 A1
(43) Pub. Date: Jun. 10, 2010

(54) SUPPORTING MULTICAST COMMUNICATIONS IN SECTORS THAT BORDER ADJACENT SUBNETS WITHIN A WIRELESS COMMUNICATIONS SYSTEM

(75) Inventor: Bongyong SONG, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/328,545

(22) Filed: Dec. 4, 2008

(51) Int. Cl. H04H 20/71

(52) U.S. Cl. 370/312

(57) ABSTRACT

Embodiments are directed to supporting multicast communications at boundary sectors within a wireless communications system. In an example, an access network configures a primary cluster for a given multicast session, the primary cluster including a plurality of sectors within a first subnet. The access network also configures a boundary cluster for the multicast session, the boundary cluster including at least one boundary sector that overlaps with a sector belonging to the primary cluster, the boundary sector being adjacent to a sector belonging to a second subnet. The access network transmits multicast packets associated with the given multicast session at each of the plurality of sectors of the primary cluster on a primary channel at a first data rate, and further transmits multicast packets associated with the given multicast session at the at least one boundary sector on a supplemental channel at a second data rate.

### BACKGROUND OF THE INVENTION

1. Field of the Invention

The invention relates to communications in a wireless telecommunication system and, more particularly to methods of supporting multicast communications in sectors that border adjacent subnets within a wireless communications system.

2. Description of the Related Art

Wireless communication systems have developed through various generations, including a first-generation analog wireless phone service (1G), a second-generation (2G) digital wireless phone service (including interim 2.5G and 2.75G networks) and a third-generation (3G) high speed data/Internet-capable wireless service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, and newer hybrid digital communication systems using both TDMA and CDMA technologies.

The method for providing CDMA mobile communications was standardized in the United States by the Telecommunications Industry Association/Electronic Industries Association in TIA/EIA/IS-95-A entitled “Mobile Station-Base Station Compatibility Standard for Dual-Mode Wideband Spread Spectrum Cellular System,” referred to herein as IS-95. Combined AMPS & CDMA systems are described in TIA/EIA Standard IS-98. Other communications systems are described in the IMT-2000/UM, or International Mobile Telecommunications System 2000/Universal Mobile Telecommunications System, standards covering what are referred to as wideband CDMA (WCDMA), CDMA2000 (such as CDMA2000 1×EV-DO standards, for example) or TD-SCDMA.

In wireless communication systems, mobile stations, handsets, or access terminals (AT) receive signals from fixed position base stations (also referred to as cell sites or cells) that support communication links or service within particular geographic regions adjacent to or surrounding the base stations. Base stations provide entry points to an access network (AN)/radio access network (RAN), which is generally a packet data network using standard Internet Engineering Task Force (IETF) based protocols that support methods for differentiating traffic based on Quality of Service (QoS) requirements. Therefore, the base stations generally interact with ATs through an over the air interface and with the AN through Internet Protocol (IP) network data packets.

In wireless telecommunication systems, Push-to-talk (PTT) capabilities are becoming popular with service sectors and consumers. PTT can support a “dispatch” voice service that operates over standard commercial wireless infrastructures, such as CDMA, FDMA, TDMA, GSM, etc. In a dispatch model, communication between endpoints (ATs) occurs within virtual groups, wherein the voice of one “talker” is transmitted to one or more “listeners.” A single instance of this type of communication is commonly referred to as a dispatch call, or simply a PTT call. A PTT call is an instantiation of a group, which defines the characteristics of a call. A group in essence is defined by a member list and associated information, such as group name or group identification.

Conventionally, data packets within a wireless communications system have been configured to be sent to a single destination or access terminal. A transmission of data to a single destination is referred to as “unicast”. As mobile communications have increased, the ability to transmit given data concurrently to multiple access terminals has become more important. Accordingly, protocols have been adopted to support concurrent data transmissions of the same packet or message to multiple destinations or target access terminals. A “broadcast” refers to a transmission of data packets to all destinations or access terminals (e.g., within a given cell, served by a given service provider, etc.), while a “multicast” refers to a transmission of data packets to a given group of destinations or access terminals. In an example, the given group of destinations or “multicast group” may include more than one and less than all of possible destinations or access terminals (e.g., within a given group, served by a given service provider, etc.). However, it is at least possible in certain situations that the multicast group comprises only one access terminal, similar to a unicast, or alternatively that the multicast group comprises all access terminals (e.g., within a cell or sector), similar to a broadcast.

Broadcasts and/or multicasts may be performed within wireless communication systems in a number of ways, such as performing a plurality of sequential unicast operations to accommodate the multicast group, allocating a unique broadcast/multicast channel (BCH) for handling multiple data transmissions at the same time and the like. A conventional system using a broadcast channel for push-to-talk communications is described in United States Patent Application Publication No. 2007/0049314 dated Mar. 1, 2007 and entitled “Push-To-Talk Group Call System Using CDMA 1×-EVDO Cellular Network”, the contents of which are incorporated herein by reference in its entirety. As described in Publication No. 2007/0049314, a broadcast channel can be used for push-to-talk calls using conventional signaling techniques. Although the use of a broadcast channel may improve bandwidth requirements over conventional unicast techniques, the conventional signaling of the broadcast channel can still result in additional overhead and/or delay and may degrade system performance.

The 3^{rd} Generation Partnership Project 2 (“3GPP2”) defines a broadcast-multicast service (BCMCS) specification for supporting multicast communications in CDMA2000 networks. Accordingly, a version of 3GPP2's BCMCS specification, entitled “CDMA2000 High Rate Broadcast-Multicast Packet Data Air Interface Specification”, dated Feb. 14, 2006, Version 1.0 C.S0054-A, is hereby incorporated by reference in its entirety.

### SUMMARY

Embodiments are directed to supporting multicast communications at boundary sectors within a wireless communications system. In an example, an access network configures a primary cluster for a given multicast session, the primary cluster including a plurality of sectors within a first subnet. The access network also configures a boundary cluster for the multicast session, the boundary cluster including at least one boundary sector that overlaps with a sector belonging to the primary cluster, the boundary sector being adjacent to a sector belonging to a second subnet. The access network transmits multicast packets associated with the given multicast session at each of the plurality of sectors of the primary cluster on a primary channel at a first data rate, and further transmits multicast packets associated with the given multicast session at the at least one boundary sector on a supplemental channel at a second data rate.

In a further example, an access terminal located within one of the boundary sectors that belongs to the first subnet and is adjacent to at least one sector belonging to the second subnet receives a message advertising a given multicast session and indicating one or more channels on a downlink upon which the given multicast session is being carried. The access terminal tunes to the one or more channels on the downlink to monitor for multicast packets associated with the given multicast session. The access terminal receives multicast packets associated with the given multicast session on multiple channels, the multiple channels including the one or more channels on the downlink indicated by the received message. The access terminal decodes the received multicast packets on the one or more channels on the downlink.

### BRIEF DESCRIPTION OF THE DRAWINGS

A more complete appreciation of embodiments of the invention and many of the attendant advantages thereof will be readily obtained as the same becomes better understood by reference to the following detailed description when considered in connection with the accompanying drawings which are presented solely for illustration and not limitation of the invention, and in which:

FIG. 1 is a diagram of a wireless network architecture that supports access terminals and access networks in accordance with at least one embodiment of the invention.

FIG. 2 illustrates the carrier network according to an example embodiment of the present invention.

FIG. 3 is an illustration of an access terminal in accordance with at least one embodiment of the invention.

FIG. 4 illustrates a plurality of sectors within a wireless communication system.

FIG. 5 illustrates wireless network architecture of the wireless communication system of FIG. 4.

FIG. 6 illustrates a cluster initialization process according to an embodiment of the present invention.

FIG. 7 illustrates the wireless communication system of FIG. 4 further indicating inter-subnet boundary clusters.

FIG. 8 illustrates broadcast overhead message (BOM) transmissions within subnets of the wireless communication system of FIG. 7.

FIG. 9 illustrates a multicast messaging process performed at a boundary sector of the wireless communication system of FIG. 7 according to an embodiment of the present invention.

FIG. 10 illustrates a cluster initialization process for a subnet-wide multicast according to an embodiment of the present invention.

FIG. 11 illustrates another wireless communication system according to an embodiment of the present invention.

FIG. 12 illustrates broadcast overhead message (BOM) transmissions within a subnet of the wireless communication system of FIG. 11.

FIG. 13 illustrates a multicast messaging process performed at a boundary sector of the wireless communication system of FIG. 11 according to an embodiment of the present invention.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention will not be described in detail or will be omitted so as not to obscure the relevant details of the invention.

The words “exemplary” and/or “example” are used herein to mean “serving as an example, instance, or illustration.” Any embodiment described herein as “exemplary” and/or “example” is not necessarily to be construed as preferred or advantageous over other embodiments. Likewise, the term “embodiments of the invention” does not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

A High Data Rate (HDR) subscriber station, referred to herein as an access terminal (AT), may be mobile or stationary, and may communicate with one or more HDR base stations, referred to herein as modem pool transceivers (MPTs) or base stations (BS). An access terminal transmits and receives data packets through one or more modem pool transceivers to an HDR base station controller, referred to as a modem pool controller (MPC), base station controller (BSC) and/or packet control function (PCF). Modem pool transceivers and modem pool controllers are parts of a network called an access network. An access network transports data packets between multiple access terminals.

The access network may be further connected to additional networks outside the access network, such as a corporate intranet or the Internet, and may transport data packets between each access terminal and such outside networks. An access terminal that has established an active traffic channel connection with one or more modem pool transceivers is called an active access terminal, and is said to be in a traffic state. An access terminal that is in the process of establishing an active traffic channel connection with one or more modem pool transceivers is said to be in a connection setup state. An access terminal may be any data device that communicates through a wireless channel or through a wired channel, for example using fiber optic or coaxial cables. An access terminal may further be any of a number of types of devices including but not limited to PC card, compact flash, external or internal modem, or wireless or wireline phone. The communication link through which the access terminal sends signals to the modem pool transceiver is called a reverse link or traffic channel. The communication link through which a modem pool transceiver sends signals to an access terminal is called a forward link or traffic channel. As used herein the term traffic channel can refer to either a forward or reverse traffic channel.

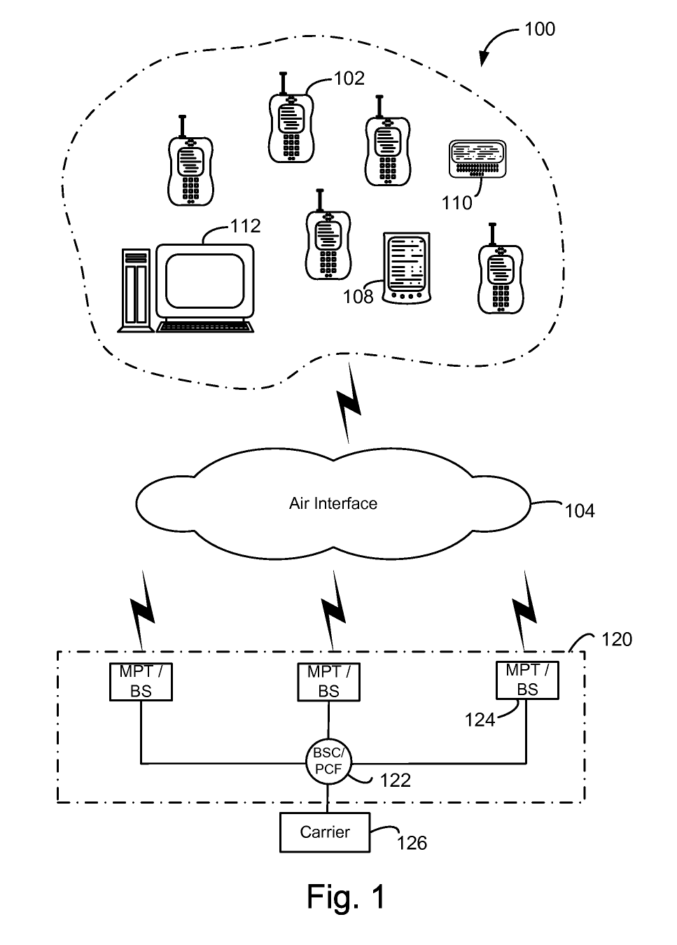

FIG. 1 illustrates a block diagram of one exemplary embodiment of a wireless system 100 in accordance with at least one embodiment of the invention. System 100 can contain access terminals, such as cellular telephone 102, in communication across an air interface 104 with an access network or radio access network (RAN) 120 that can connect the access terminal 102 to network equipment providing data connectivity between a packet switched data network (e.g., an intranet, the Internet, and/or carrier network 126) and the access terminals 102, 108, 110, 112. As shown here, the access terminal can be a cellular telephone 102, a personal digital assistant 108, a pager 110, which is shown here as a two-way text pager, or even a separate computer platform 112 that has a wireless communication portal. Embodiments of the invention can thus be realized on any form of access terminal including a wireless communication portal or having wireless communication capabilities, including without limitation, wireless modems, PCMCIA cards, personal computers, telephones, or any combination or sub-combination thereof. Further, as used herein, the terms “access terminal”, “wireless device”, “client device”, “mobile terminal” and variations thereof may be used interchangeably.

Referring back to FIG. 1, the components of the wireless network 100 and interrelation of the elements of the exemplary embodiments of the invention are not limited to the configuration illustrated. System 100 is merely exemplary and can include any system that allows remote access terminals, such as wireless client computing devices 102, 108, 110, 112 to communicate over-the-air between and among each other and/or between and among components connected via the air interface 104 and RAN 120, including, without limitation, carrier network 126, the Internet, and/or other remote servers.

The RAN 120 controls messages (typically sent as data packets) sent to a base station controller/packet control function (BSC/PCF) 122. The BSC/PCF 122 is responsible for signaling, establishing, and tearing down bearer channels (i.e., data channels) between a packet data service node 100 (“PDSN”) and the access terminals 102/108/110/112. If link layer encryption is enabled, the BSC/PCF 122 also encrypts the content before forwarding it over the air interface 104. The function of the BSC/PCF 122 is well-known in the art and will not be discussed further for the sake of brevity. The carrier network 126 may communicate with the BSC/PCF 122 by a network, the Internet and/or a public switched telephone network (PSTN). Alternatively, the BSC/PCF 122 may connect directly to the Internet or external network. Typically, the network or Internet connection between the carrier network 126 and the BSC/PCF 122 transfers data, and the PSTN transfers voice information. The BSC/PCF 122 can be connected to multiple base stations (BS) or modem pool transceivers (MPT) 124. In a similar manner to the carrier network, the BSC/PCF 122 is typically connected to the MPT/BS 124 by a network, the Internet and/or PSTN for data transfer and/or voice information. The MPT/BS 124 can broadcast data messages wirelessly to the access terminals, such as cellular telephone 102. The MPT/BS 124, BSC/PCF 122 and other components may form the RAN 120, as is known in the art. However, alternate configurations may also be used and the invention is not limited to the configuration illustrated. For example, in another embodiment the functionality of the BSC/PCF 122 and one or more of the MPT/BS 124 may be collapsed into a single “hybrid” module having the functionality of both the BSC/PCF 122 and the MPT/BS 124.

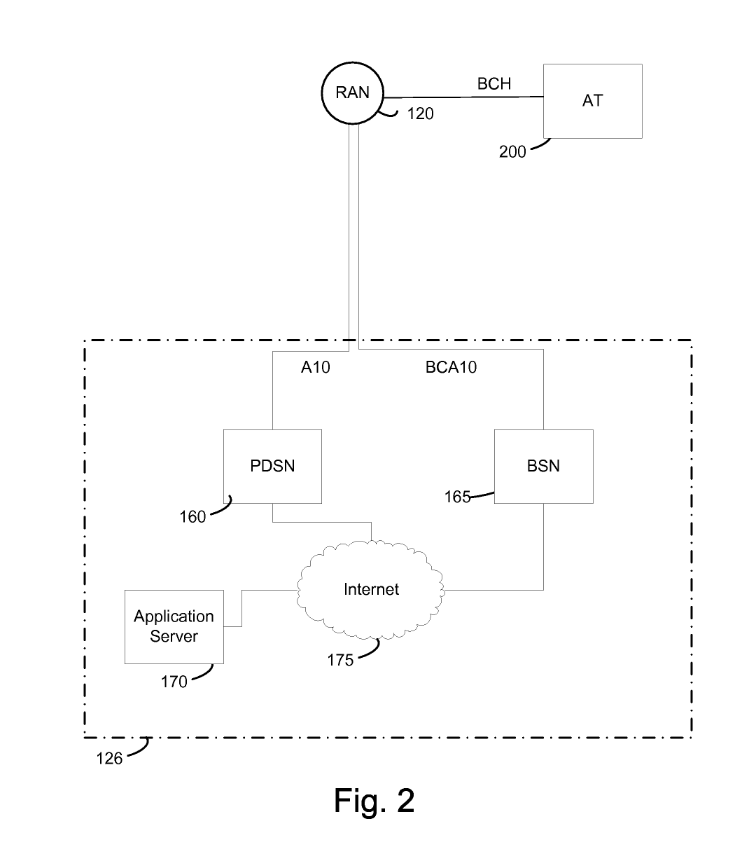

FIG. 2 illustrates the carrier network 126 according to an embodiment of the present invention. In the embodiment of FIG. 2, the carrier network 126 includes a packet data serving node (PDSN) 160, a broadcast serving node (BSN) 165, an application server 170 and an Internet 175. However, application server 170 and other components may be located outside the carrier network in alternative embodiments. The PDSN 160 provides access to the Internet 175, intranets and/or remote servers (e.g., application server 170) for mobile stations (e.g., access terminals, such as 102, 108, 110, 112 from FIG. 1) utilizing, for example, a cdma2000 Radio Access Network (RAN) (e.g., RAN 120 of FIG. 1). Acting as an access gateway, the PDSN 160 may provide simple IP and mobile IP access, foreign agent support, and packet transport. The PDSN 160 can act as a client for Authentication, Authorization, and Accounting (AAA) servers and other supporting infrastructure and provides mobile stations with a gateway to the IP network as is known in the art. As shown in FIG. 2, the PDSN 160 may communicate with the RAN 120 (e.g., the BSC/PCF 122) via a conventional A10 connection. The A10 connection is well-known in the art and will not be described further for the sake of brevity.

Referring to FIG. 2, the broadcast serving node (BSN) 165 may be configured to support multicast and broadcast services. The BSN 165 will be described in greater detail below. The BSN 165 communicates with the RAN 120 (e.g., the BSC/PCF 122) via a broadcast (BC) A10 connection, and with the application server 170 via the Internet 175. The BCA10 connection is used to transfer multicast and/or broadcast messaging. Accordingly, the application server 170 sends unicast messaging to the PDSN 160 via the Internet 175, and sends multicast messaging to the BSN 165 via the Internet 175.

Generally, as will be described in greater detail below, the RAN 120 transmits multicast messages, received from the BSN 165 via the BCA10 connection, over a broadcast channel (BCH) of the air interface 104 to one or more access terminals 200.

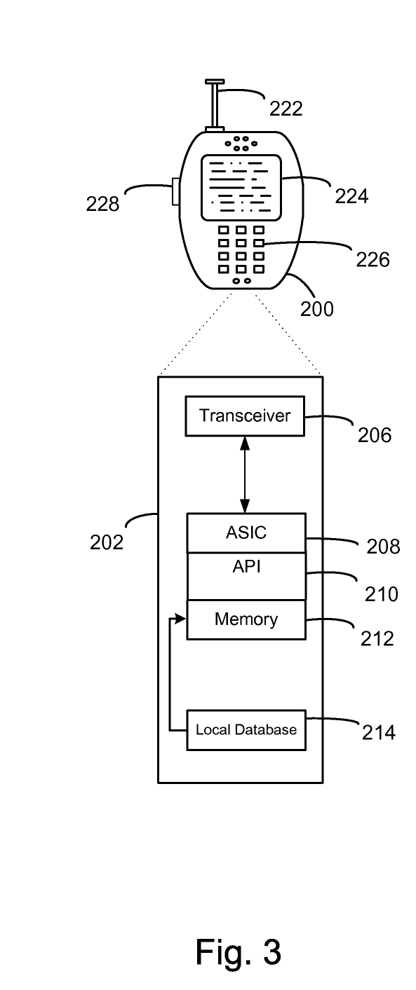

Referring to FIG. 3, an access terminal 200, (here a wireless device), such as a cellular telephone, has a platform 202 that can receive and execute software applications, data and/or commands transmitted from the RAN 120 that may ultimately come from the carrier network 126, the Internet and/or other remote servers and networks. The platform 202 can include a transceiver 206 operably coupled to an application specific integrated circuit (“ASIC” 208), or other processor, microprocessor, logic circuit, or other data processing device. The ASIC 208 or other processor executes the application programming interface (“API’) 210 layer that interfaces with any resident programs in the memory 212 of the wireless device. The memory 212 can be comprised of read-only or random-access memory (RAM and ROM), EEPROM, flash cards, or any memory common to computer platforms. The platform 202 also can include a local database 214 that can hold applications not actively used in memory 212. The local database 214 is typically a flash memory cell, but can be any secondary storage device as known in the art, such as magnetic media, EEPROM, optical media, tape, soft or hard disk, or the like. The internal platform 202 components can also be operably coupled to external devices such as antenna 222, display 224, push-to-talk button 228 and keypad 226 among other components, as is known in the art.

Accordingly, an embodiment of the invention can include an access terminal including the ability to perform the functions described herein. As will be appreciated by those skilled in the art, the various logic elements can be embodied in discrete elements, software modules executed on a processor or any combination of software and hardware to achieve the functionality disclosed herein. For example, ASIC 208, memory 212, API 210 and local database 214 may all be used cooperatively to load, store and execute the various functions disclosed herein and thus the logic to perform these functions may be distributed over various elements. Alternatively, the functionality could be incorporated into one discrete component. Therefore, the features of the access terminal in FIG. 3 are to be considered merely illustrative and the invention is not limited to the illustrated features or arrangement.

The wireless communication between the access terminal 102 and the RAN 120 can be based on different technologies, such as code division multiple access (CDMA), WCDMA, time division multiple access (TDMA), frequency division multiple access (FDMA), Orthogonal Frequency Division Multiplexing (OFDM), the Global System for Mobile Communications (GSM), or other protocols that may be used in a wireless communications system or a data communications system. The data communication is typically between the client device 102, MPT/BS 124, and BSC/PCF 122. The BSC/PCF 122 can be connected to multiple data networks such as the carrier network 126, PSTN, the Internet, a virtual private network, and the like, thus allowing the access terminal 102 access to a broader communication network. As discussed in the foregoing and known in the art, voice transmission and/or data can be transmitted to the access terminals from the RAN using a variety of networks and configurations. Accordingly, the illustrations provided herein are not intended to limit the embodiments of the invention and are merely to aid in the description of aspects of embodiments of the invention.

### Discussion of Soft-Combining in Multicast Communications

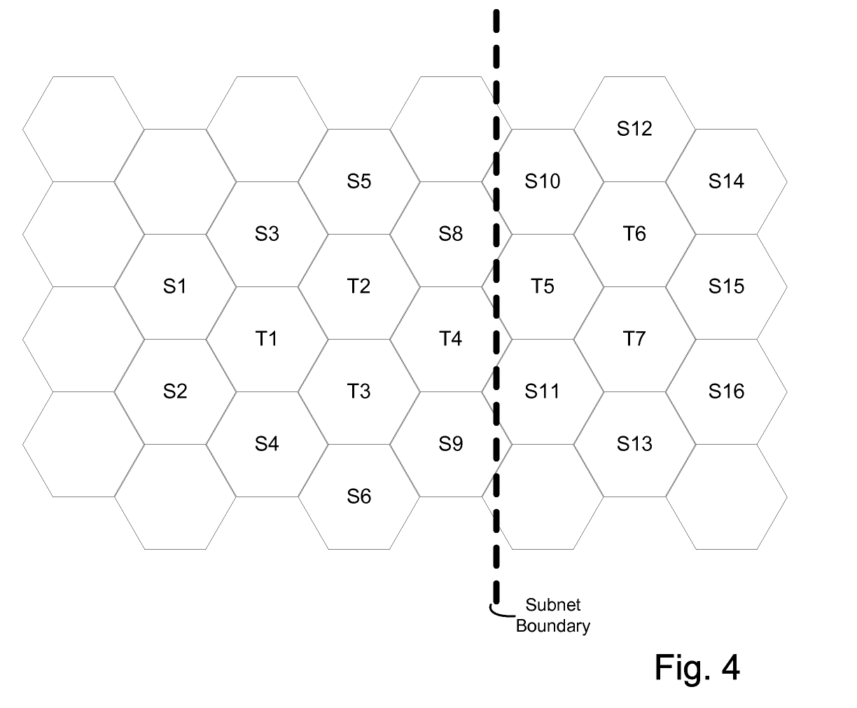

FIG. 4 illustrates a plurality of sectors within a wireless communication system. With respect to FIG. 4, each labeled sector (S1-S16 and T1-T7) among the plurality of sectors corresponds to a sector that carries a multicast flow (e.g., a broadcast multicast service (BCMCS) flow. Sectors S1-S16 correspond to “supporting sectors”, and sectors T1-T7 correspond to “target sectors”. The behaviors and characteristics of supporting sectors and target sectors are discussed in greater detail in U.S. Provisional Patent Application No. 60/974,808, entitled “METHODS OF SUPPORTING MULTICAST COMMUNICATIONS ASSOCIATED WITH OVERLAPPING CLUSTERS WITHIN A WIRELESS COMMUNICATIONS NETWORK”, filed on Sep. 24, 2007, assigned to the assignee hereof, and expressly incorporated by reference herein in its entirety. Generally, target sectors include at least one access terminal participating in a given multicast session, while supporting sectors (e.g., neighbor sectors, neighbor sectors of neighbor sectors, etc.) do not include participating access terminals (“multicast group members”) and carry the multicast flow, at least in part, to facilitate “soft-combining” at multicast group members in target sectors.

Soft-combining is an important feature in multicast communication protocols, such as BCMCS. Soft-combining generally refers to access terminals using transmissions within the access terminal's current sector in conjunction with signals transmitted from other sectors to better resolve the transmissions. In the BCMCS framework, this means that, if necessary, multicast group members can use downlink broadcasts for the BCMCS session (e.g., a push-to-talk (PTT) session) transmitted in supporting sectors or other target sectors to help decode the downlink broadcasts for the BCMCS session of the current serving sectors of the multicast group members.

Typically, an access terminal (AT) monitoring a BCMCS flow can obtain relatively high soft-combining gain if (i) all nearby sectors use the same interlace-multiplex (IM) pair and (ii) the nearby sectors' transmissions are synchronized (i.e., each sector transmits the same packets at the same time). Generally, as is known in the art, each BCMCS flow is carried on a given IM pair within a particular subnet. Access terminals that wish to participate in a BCMCS session monitor broadcast overhead messages (BOMs) sent by the RAN 120. BOMs advertise BCMCS flows (e.g., by listing an associated BCMCSFIowID) and indicate an associated IM pair by which the access terminal can “tune” to a particular BCMCS flow on a downlink broadcast channel (BCH). This manner of using IM pairs to carry different BCMCS flows is well-known in the art, and is discussed in more detail within Publication No. 2007/0049314 (i.e., incorporated by reference in the Background section).

The soft combining conditions (i) and (ii) are relatively easy to satisfy at interior sectors of a subnet (i.e., sectors that are surrounded by sectors of the same subnet) if a broadcast area of the multicast session spans a single “subnet”. As used herein, a subnet refers to a set of sectors that are controlled by a single network element at the RAN 120, such as a BSC/PCF 122 as described above with respect to FIG. 1, a radio network controller (RNC), or other network element. RNCs, for example, are typically used in UMTS RANs that control one or more base stations, referred to as Node Bs. Below, reference is made to subnets that are each under the control of a single RNC. However, as will be appreciated by one of ordinary skill in the art, based upon which standard the RAN 120 is configured to comply with (e.g., UMTS, GSM, etc.), other network elements can be used in place of RNCs. As such, the use of the term RNC below is not intended to limit embodiments of the present invention to UMTS. Thus, the soft combining conditions (i) and (ii) can be satisfied at interior sectors of a subnet because the subnet's RNC can instruct each base station to transmit the BCMCS flow on the same IM pair and at substantially the same time.

However, if the broadcast area for the BCMCS flow spans multiple subnets, it becomes more difficult to satisfy soft combining conditions (i) and (ii). Referring to FIG. 4, target sectors T1 through T4 and supporting sectors S1 through S9 are included within a first subnet controlled by a first RNC, and target sectors T5 through T7 and supporting sectors S10 through S16 are included within a second subnet controlled by a second RNC. A subnet boundary between the first and second subnets is illustrated as a vertical dotted line in FIG. 4.

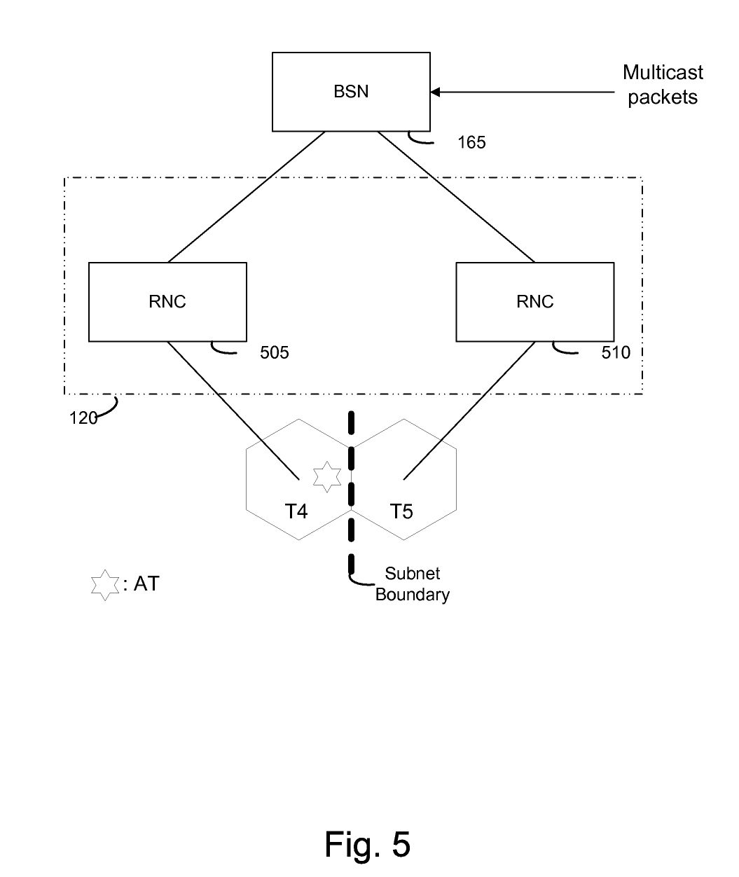

An example describing the difficulties of inter-subnet soft combining will now be given with respect to FIG.5. Referring to FIG. 5, the first RNC controlling S1-S9 and T1-T4 corresponds to RNC 505 and the second RNC controlling S10-S16 and T5-T7 corresponds to RNC 510. As shown, RNCs 505 and 510 are included within the RAN 120 (e.g., in place of the BSC/PCF 122 of FIG. 1). Multicast packets are received at the BSN 165 (e.g., from the application server 170), and the BSN 165 forwards the multicast packets to the first and second RNCs 505 and 510 because each of RNCs 505 and 510 include at least one target sector.

Referring to FIG. 5, target sector T4 of the first subnet and target sector T5 of the second subnet are illustrated. While not shown explicitly, it is understood that each of target sectors T4 and T5 are served by a given MPT/BS 124 or Node B, to which RNCs 505 and 510 are respectively connected. An access terminal participating in the multicast session is positioned in target sector T4 of the first subnet relatively close to the subnet boundary with the second subnet.

As will be appreciated in view of the discussion provided above, soft combining at the access terminal positioned in target sector T4 is made easier if the two soft combining conditions are satisfied. With regard to IM pair synchronization for the multicast session, RNC 505 of the first subnet and RNC 510 of the second subnet do not necessarily use the same IM pair. Accordingly, to satisfy soft combining condition (i) by having the multicast session carried on the same IM pair of the downlink BCH in target sectors T4 and T5, the RNCs 505 and 510 need to communicate and agree upon an IM pair to be used in both subnets. Because the number of subnets carrying a multicast session can be greater than two, this IM pair negotiation between RNCs of different subnets can be relatively complicated because the same IM pair may not be available in all participating subnet.

Furthermore, even assuming all subnets in the wireless communication system are configured to use the same IM pair for a particular multicast session, this alone cannot guarantee that soft combining condition (ii) is satisfied. In other words, the packets associated with the multicast session are not necessarily transmitted at each sector within each subnet at the same time. As an example, the first and second RNCs 505 and 510 each receive multicast packets “individually” from the BSN 165. Accordingly, the arrival time of a given multicast packet at RNCs 505 and 510 is not necessarily the same (e.g., if the multicast packet is transmitted to the RNCs 505 and 510 at different times, if there is a different backhaul delay between the BSN 165 and RNCs 505 and 510, etc.). Thus, even assuming the first and second subnets of FIGS. 4 and 5 agree to use the same IM pair for the multicast session, if RNC 505 receives the given multicast packet before the IM pair on the downlink BCH, and RNC 510 receives the given multicast packet after the IM pair, the transmission of the multicast packet at RNCs 505 and 510 is not synchronized such that soft combining condition (ii) is not satisfied. Therefore, it can be difficult to ensure that soft combining is available to access terminals that are relatively close to a subnet boundary.

### Establishing Boundary Clusters for Reliable Multicasting at a Subnet boundary

As discussed above, it can be relatively difficult to provide access terminals participating in a multicast session (e.g., a BCMCS session, such as a PTT call) and positioned relatively close to a subnet boundary with signals sufficient to permit soft combining. Accordingly, embodiments of the present invention, which will now be described in greater detail, are directed to providing a secondary or supplemental channel carrying the multicast flow within “boundary” sectors (e.g., sectors in a first subnet that are adjacent to sectors in a second subnet).

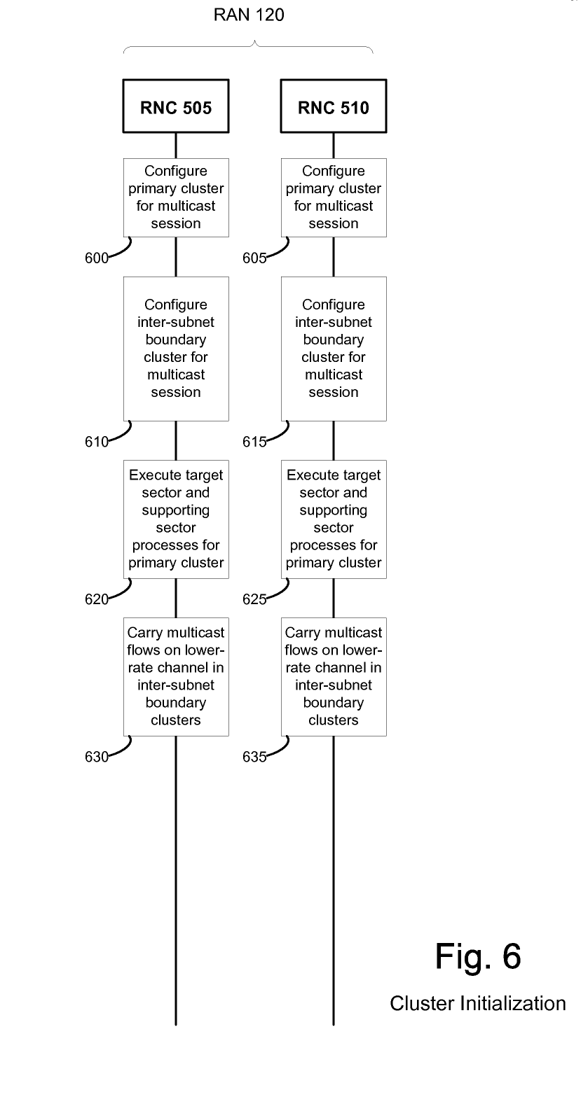

FIG. 6 illustrates a cluster initialization process according to an embodiment of the present invention. As used herein, a “cluster” corresponds to a set of sectors (e.g., one or more sectors) upon which the downlink BCH carries the BCMCS flow for a particular multicast session.

Referring to FIG. 6, in 600 and 605, RNCs 505 and 510 each configure a primary cluster of the first and second subnets, respectively, for a given multicast session. As used herein, a “primary” cluster corresponds to a group of target sectors and supporting sectors (e.g., as shown in FIG. 4). Referring to FIG. 4, the primary cluster of the first subnet for RNC 505 includes target sectors T1 through T4, and the primary cluster of the second subnet for RNC 510 includes target sectors T5 through T7 and supporting sectors S10 through S16. The primary cluster is subnet-specific, such that any primary cluster only includes sectors belonging to one particular subnet or controlled by a single RNC. A more detailed explanation of cluster establishment, as well as how clusters can be updated to accommodate changes to where access terminals are located, can be found within U.S. Provisional Patent Application No. 60/974,808, entitled “METHODS OF SUPPORTING MULTICAST COMMUNICATIONS ASSOCIATED WITH OVERLAPPING CLUSTERS WITHIN A WIRELESS COMMUNICATIONS NETWORK”, filed on Sep. 24, 2007, assigned to the assignee hereof, which has already been incorporated by reference in its entirety above. The configuring steps 600 and 605 include an IM pair assignment to the first and second primary clusters of the first and second subnets, respectively. In an example, if the RNCs 505 and 510 have sufficient IM pair resources, an agreement can be made between RNCs 505 and 510 such that the same IM pair is assigned to the first and second primary clusters. Alternatively, the first and second primary clusters may not necessarily be assigned the same IM pair on the downlink BCH on which the carry the multicast session.

Next, in 610 and 615, RNCs 505 and 510 each configure an inter-subnet boundary cluster for the multicast session. The inter-subnet boundary cluster for the first subnet controlled by RNC 505 includes target sectors of the first primary cluster that are adjacent to a sector of another subnet, and the inter-subnet boundary cluster for the second subnet controlled by RNC 510 includes target sectors of the second primary cluster that are adjacent to a sector of another subnet. Accordingly, an inter-subnet boundary cluster is a subset of its subnet's primary cluster.

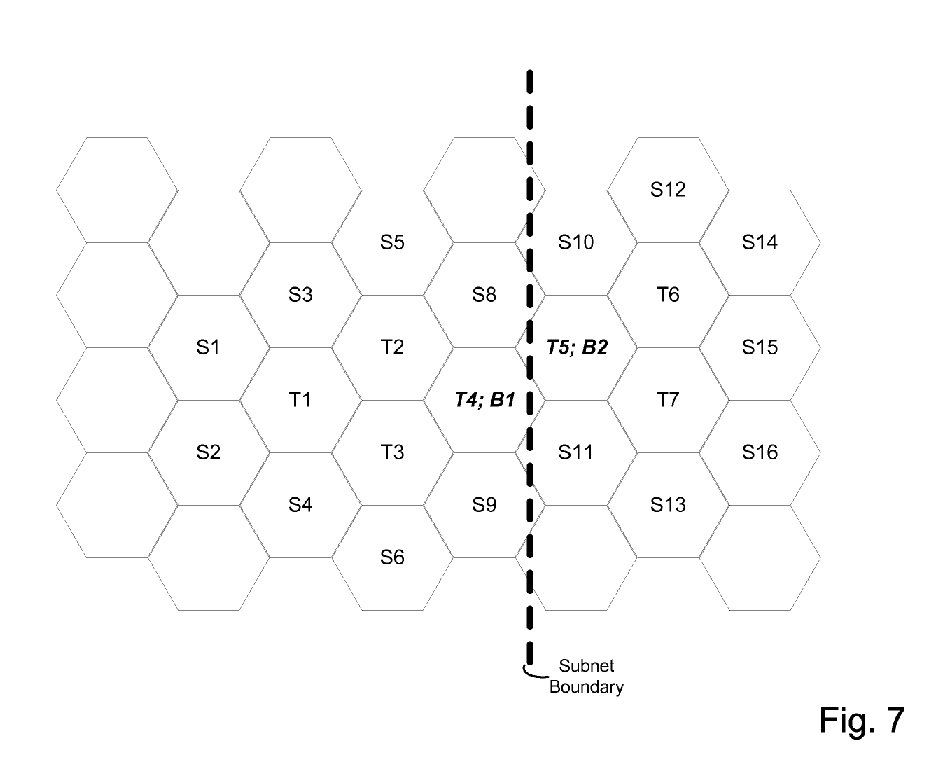

FIG. 7 illustrates the wireless communication system of FIG. 4 further indicating the inter-subnet boundary clusters of the first and second subnets. Accordingly, the inter-subnet boundary cluster for the first subnet, 610, includes boundary sector B1, which overlaps with target sector T4 of the first primary cluster. The inter-subnet boundary cluster for the second subnet, 615, includes boundary sector B2, which overlaps with target sector T5 of the second primary cluster.

Returning to FIG. 6, the configuring steps of 610 and 615 further include an IM pair assignment to the first and second inter-subnet boundary clusters of the first and second subnets, respectively. The IM pairs assigned to the first and second inter-subnet boundary clusters is different than the IM pair assigned to a primary clusters that overlap with the first and second inter-subnet boundary clusters.

In 620 and 625, the target sectors and supporting sectors of the first and second primary clusters execute target sector processes and supporting sector processes, respectively. Again, a detailed description of the target sector and supporting sector processes has been incorporated by reference to a co-pending application, as discussed above. For example, both the target and supporting sectors carry the multicast flow on the assigned IM pair, and further advertise the multicast session, based on an associated BCMCSFIowID, in one or more BOMs. In another example, the target and supporting sectors may differ in BOM configuration such that a RFDB bit of supporting sector BOMs is configured to prompt access terminals to register for the multicast session, whereas the RFDB bit of target sector BOMs may be configured not to prompt access terminals to register for the multicast session.

In 630 and 635, the first and second inter-subnet boundary clusters carry the multicast flow at each boundary sector on the assigned supplemental IM pair of the downlink BCH. In an example, the inter-subnet boundary clusters carry the multicast flow on the assigned supplemental IM pair of the downlink BCH at a lower data rate than the primary IM pair of the primary clusters. For example, if the primary clusters carry the multicast flow at 307.2 kilobits per second (kbps), then the boundary clusters carry the multicast flow at 76.8 kbps. Because the supplemental IM pair may be configured with a relatively conservative data rate (e.g., compared to the primary IM pair), the difficulty of decoding the supplemental IM pair in the boundary cluster is reduced as compared to the primary IM pair. Thus, more access terminals within the boundary cluster may be capable of decoding the supplemental IM pair than he primary IM pair. For example, the access terminals located close to the subnet boundary (e.g., further from a base station serving a given sector in the boundary cluster) may have more difficulty decoding the primary IM pair than access terminals closer to the serving base station. Accordingly, the access terminals near the subnet boundary may benefit from the supplemental IM pair.

In order for access terminals to decode multicast packets at the boundary clusters, the access terminals need to be informed that the supplemental IM pair is carrying multicast packets for the multicast session. As discussed above, BOMs are used to advertise BCMCS flows and to instruct ATs with regard to associated IM pairs of the downlink BCH that are carrying the respective BCMCS flow. Accordingly, sectors in the first and second subnet that are target sectors of a primary cluster and also belong to a boundary cluster modify their BOMs to indicate both (i) the primary IM pair of the primary cluster and (ii) the supplemental IM pair of the boundary cluster. Further, the PhysicalChannelCount field, which indicates the number of channels or IM pairs that carry the advertised BCMCS flow can be set to either 1 or 2. If the PhysicalChannelCount field is set to 1, only the supplemental IM pair will be advertised in the BOM. Thus, in this case, a multicast group member will decode only the primary IM pair. In another example, if the PhysicalChannelCount field is set to 2, both of the primary and supplemental IM pairs will be advertised in the BOM. In this case, a multicast group member will try to decode both the primary and supplemental IM pairs on the downlink BCH.

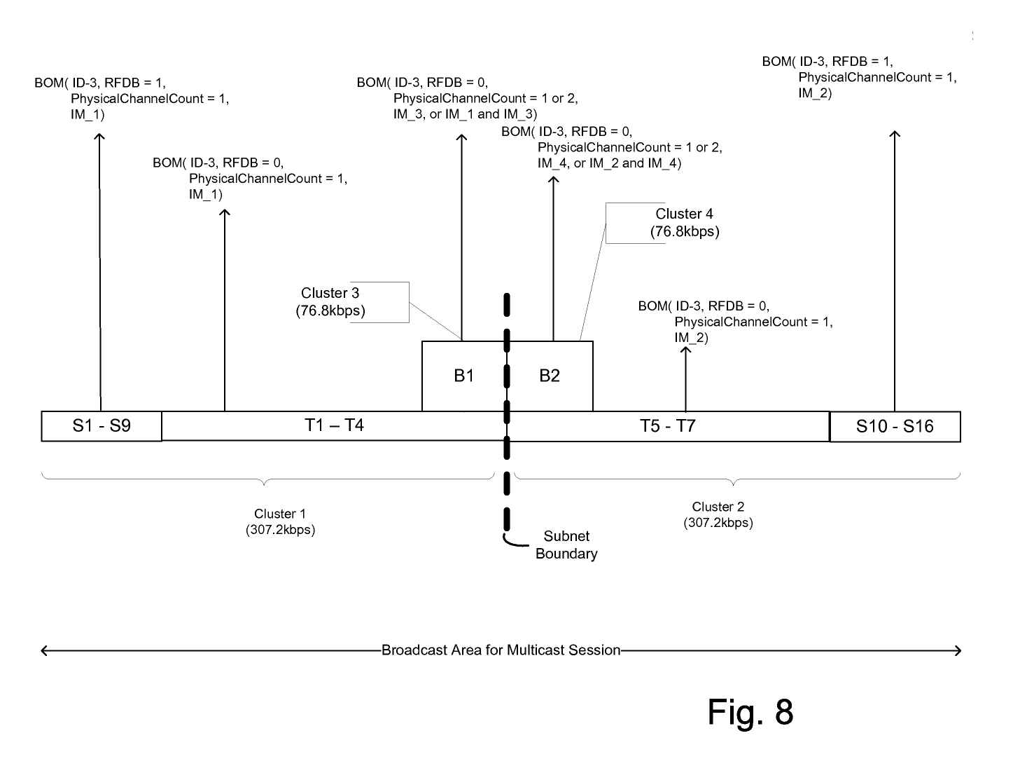

An example of BOM transmissions at the first and second subnets within the wireless communication system of FIG. 7 will now be described with respect to FIG. 8. In FIG. 8, the primary cluster of the first subnet corresponds to Cluster 1, the primary cluster of the second subnet corresponds to Cluster 2, the inter-subnet boundary cluster of the first subnet corresponds to Cluster 3, and the inter-subnet boundary cluster of the second subnet corresponds to Cluster 4. The primary IM pair of Cluster 1 is IM_1, the primary IM pair of Cluster 2 is IM_2, the supplemental IM pair of Cluster 3 is IM_3 and the supplemental IM pair of Cluster 4 is IM_4. Further, while a boundary sector (e.g., B1 or B2) overlaps with a target sector of a primary cluster, the BOMs for the boundary sectors and overlapping target sectors are shown separately for convenience of description. It will be appreciated, however, that the actual BOM transmitted in the overlapping sector would be the BOM indicated for the boundary sector. It is further assumed, in FIG. 8, that the data rate of the primary clusters is 307.2 kbps, and that the data rate of the boundary clusters is 76.8 kbps. However, it will be appreciated that these data rates have been provided for example purposes only, and that other embodiments of the present invention can be directed to primary and boundary clusters associated with different data rates.

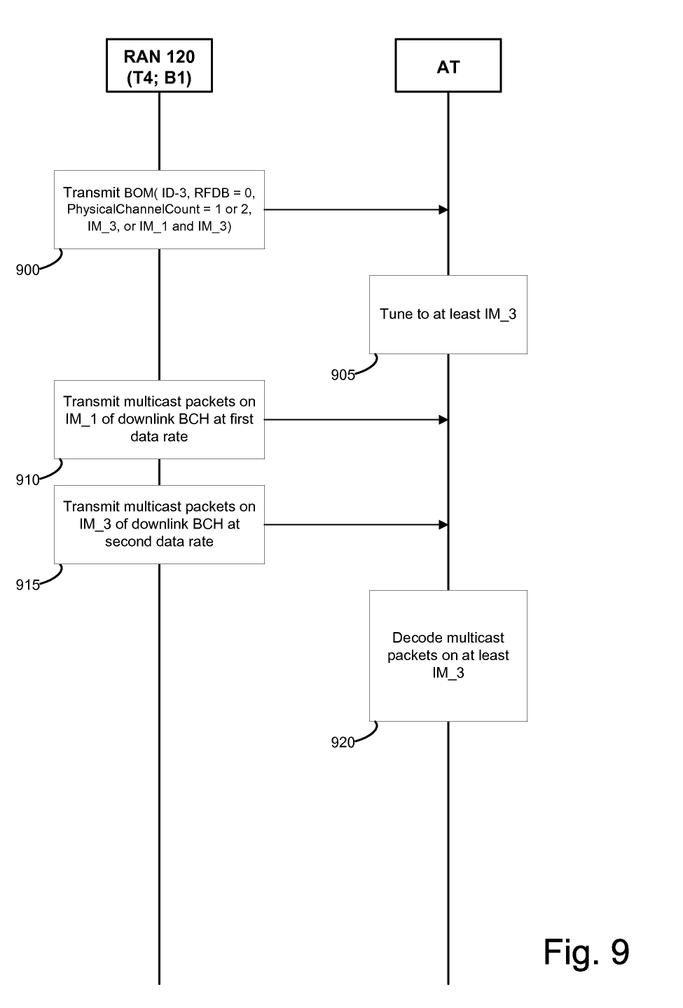

FIG. 9 illustrates a multicast messaging process performed at a boundary sector according to an embodiment of the present invention. In particular, FIG. 9 illustrates a multicast messaging process performed at boundary sector B1 (which is also target sector T4) within the first subnet based on the assumptions provided above with respect to FIG. 8. In 900, the RAN 120 transmits a BOM associated with an announced multicast session. The BOM advertises at least one BCMCSFIowID (e.g., “ID-3”), sets an RFDB bit to instruct access terminals not to transmit registration requests (e.g., “RFDB=0”), sets the PhysicalChannelCount to either 1 or 2, and lists either IM_3 only (e.g., if PhysicalChannelCount=1) or both IM_1 and IM_3 (e.g., if PhysicalChannelCount=2) as carrying the advertised BCMCS flow. An access terminal within the boundary sector B1 receives the BOM and tunes to IM_3, or IM_1 and IM_3 depending on the value of the PhysicalChannelCount, 905.

Referring to FIG. 9, in 910, the RAN 120 transmits multicast packets associated with the advertised BCMCS flow on IM_1 of the downlink BCH in boundary sector B1 at a first data rate (e.g., 307.2 kbps). In 915, the RAN 120 transmits multicast packet associated with the advertised BCMCS flow on IM_3 of the downlink BCH in boundary sector B1 at a second data rate (e.g., 76.8 kbps). In 920, the AT decodes the multicast packets based on IM_3, 910, or IM_1 and IM_3, 915, transmissions, depending on whether the BOM advertises both channels.

As will be appreciated by one of ordinary skill in the art, the access terminal in 920 has a better chance of decoding the multicast packets based on both IM_1 and IM_3 transmissions as compared to decoding the multicast packets on IM_3 alone, because a successful decoding of either of the IM pairs means that the AT can successfully decode a multicast packet. This decoding benefit is achieved at the expense of extra resources being allocated for the supplemental IM pair on the downlink BCH.

While the above-described embodiment of the present invention has been directed to a boundary cluster established with respect to a single subnet boundary for an inter-subnet multicast, boundary clusters can also be configured for intra-subnet multicasts (i.e., multicasts occurring within a single subnet) for a subnet having boundaries with two or more other subnets. Accordingly, another embodiment of the present invention is directed to a subnet-wide multicast for a subnet with multiple subnet boundaries, as will now be described in greater detail.

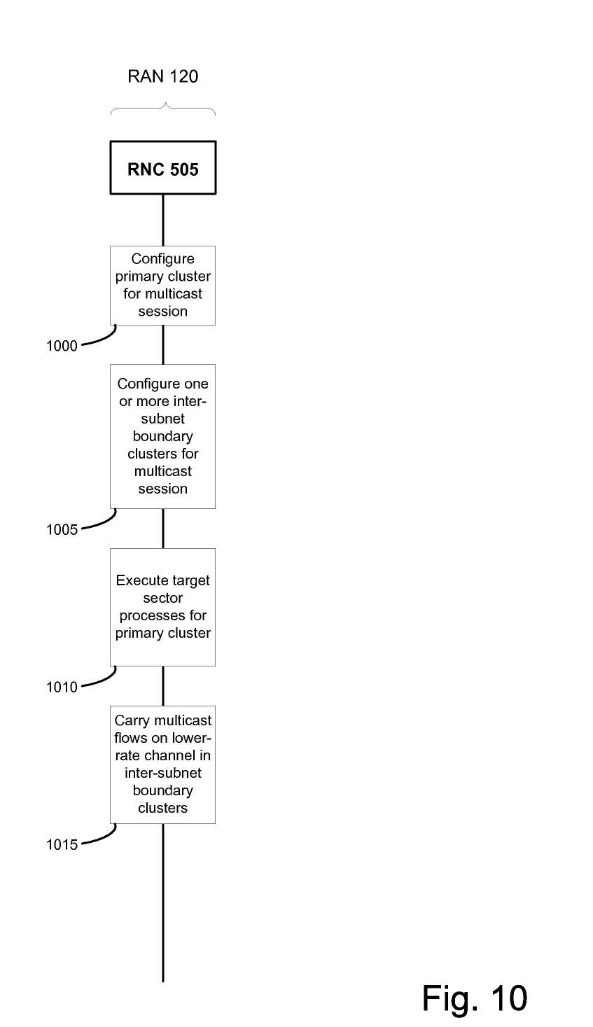

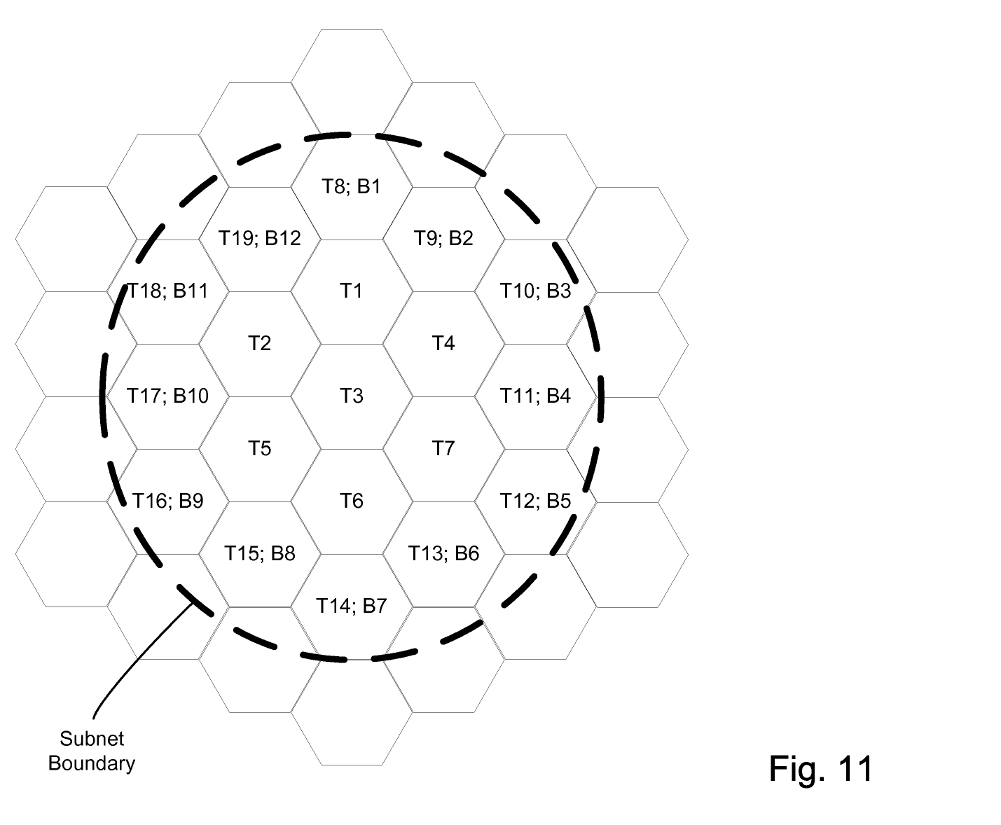

FIG. 10 illustrates a cluster initialization process for a subnet-wide multicast according to an embodiment of the present invention. Referring to FIG. 10, assume that RNC 505 has been instructed to transmit multicast messages in each sector of the subnet controlled by RNC 505. This means each sector of the subnet controlled by RNC 505 is interpreted as a target sector irrespective of whether a target AT is actually present within each sector (e.g., such that the RNC 505 need not actually check a database maintained at the RAN 120 to determine which sectors are target sectors, which are supporting sectors and which are non-supporting sectors). Further assume that the subnet of RNC 505 is illustrated in FIG. 11, and includes target sectors T1 through T19.

Accordingly, in 1000, RNC 505 configures a primary cluster for the subnet-wide multicast session. Also in 1000, the RNC 505 assigns an IM pair to the primary cluster. In an example, if the multicast session is carried in other subnets, the RNC 505 may attempt to coordinate its IM pair assignment with RNCs of the other subnets carrying the multicast session. Here, because the multicast session is to be carried in all sectors of the subnet of RNC 505, the primary cluster includes each of target sectors T1 through T19.

Next, in 1005, RNC 505 configures one or more inter-subnet boundary clusters for the multicast session. Referring to FIG. 11, each of target sectors T8 through T19 are boundary sectors because each of sectors T8 through T19 border, or are adjacent to, at least one sector controlled by another RNC. Thus, sectors T8 through T19 may alternatively be referred to as boundary sectors B1 through B12. The supplemental IM pairs assigned to each boundary cluster may be the same, or alternatively may be different from each other. In an example, the supplemental IM pairs assigned to each boundary cluster may be the same such that the AT in a boundary cluster could soft-combine supplemental IM pair signals from different boundary sectors. In 1010, the target sectors T1 through T19 execute their respective processes as described above with respect to steps 620 and 625 of FIG. 6. Also, a detailed description of the target sector processes has been incorporated by reference to a co-pending application above

In 1015, the boundary cluster or clusters for the subnet of RNC 505 carry the multicast flow at each boundary sector (i.e., B1 through B12 or T8 through T19) on the assigned supplemental IM pair of the downlink BCH. In an example, the inter-subnet boundary cluster or clusters carry the multicast flow on the assigned supplemental IM pair of the downlink BCH at a lower data rate than the primary IM pair of the primary clusters. For example, if the primary cluster carries the multicast flow at 307.2 kilobits per second (kbps), then each boundary cluster carries the multicast flow at 76.8 kbps.

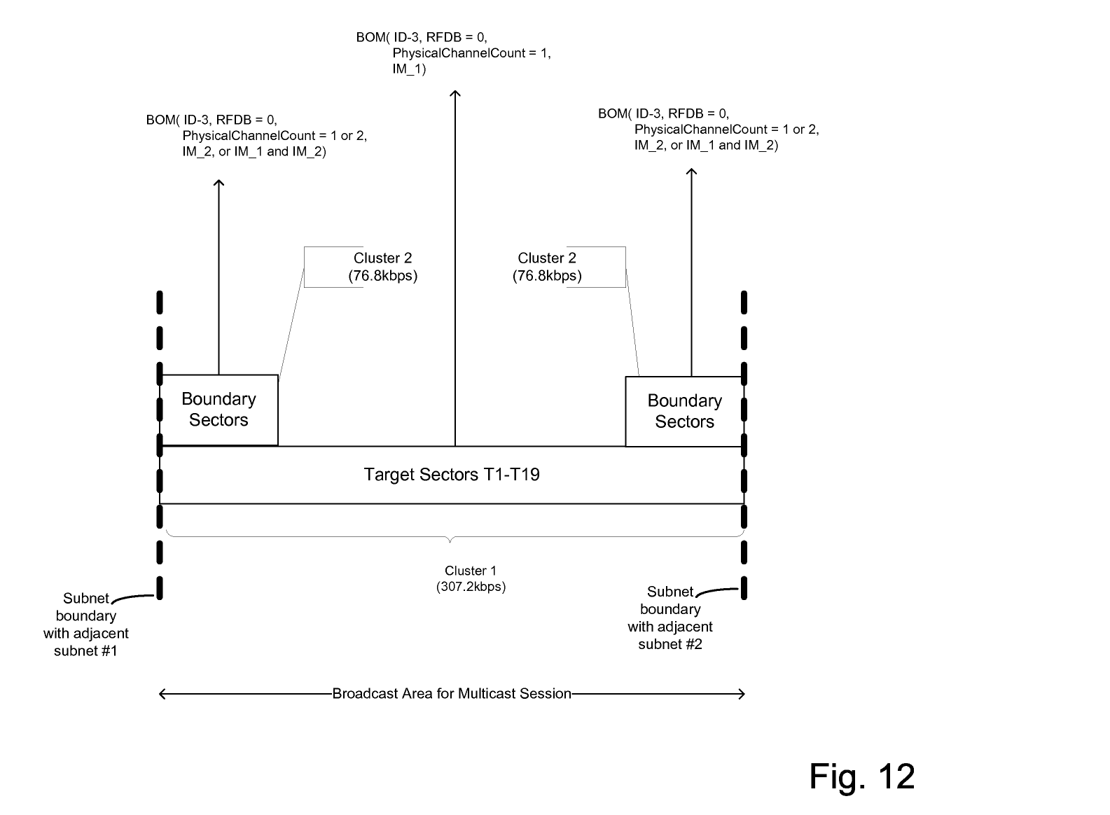

An example of BOM transmissions at the subnet of RNC 505 within the wireless communication system of FIG. 11 will now be described with respect to FIG. 12. In FIG. 12, the primary cluster corresponds to Cluster 1, and an inter-subnet boundary cluster of the subnet corresponds to Cluster 2. The primary IM pair of Cluster 1 is IM_1, and the supplemental IM pair of Cluster 2 is IM_2. Further, it is assumed in FIG. 12 that the data rate of the Cluster 1 (i.e., the primary cluster) is 307.2 kbps, and that the data rate of Cluster 2 is 76.8 kbps. However, it will be appreciated that these data rates have been provided for example purposes only, and that other embodiments of the present invention can be directed to primary and boundary clusters associated with different data rates.

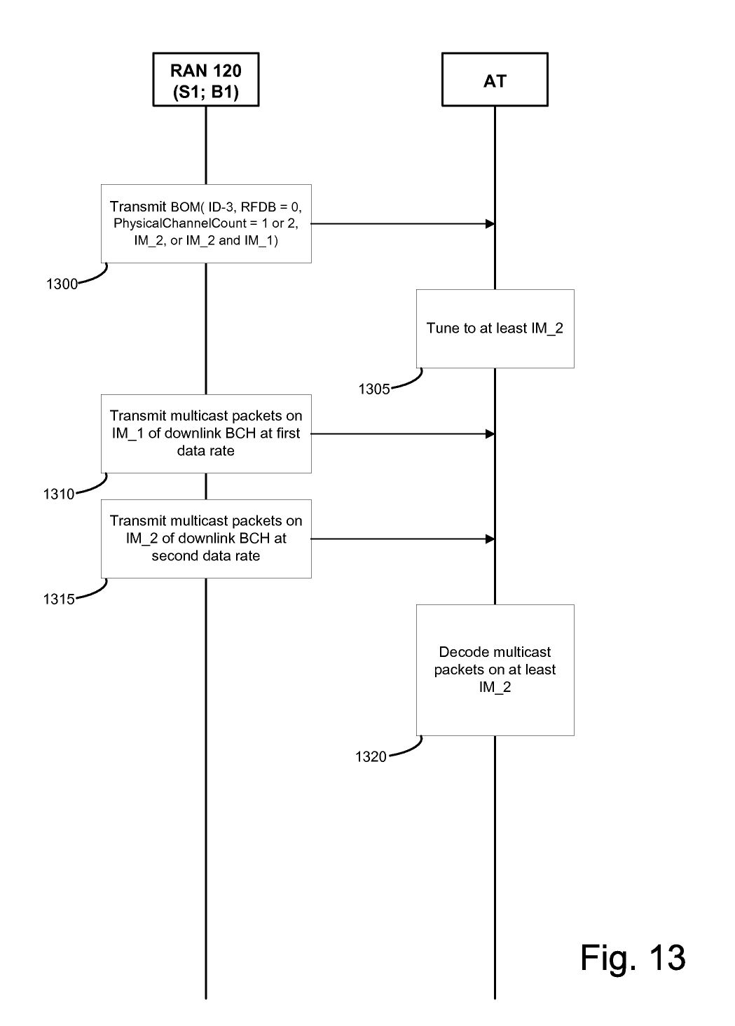

FIG. 13 illustrates a multicast messaging process performed at a boundary sector according to an embodiment of the present invention. In particular, FIG. 13 illustrates a multicast messaging process performed at boundary sector B1 belonging to Cluster 2 based on the assumptions provided above with respect to FIGS. 10, 11 and 12. In 1300, the RAN 120 transmits a BOM associated with an announced multicast session. The BOM advertises at least one BCMCSFIowID (e.g., “ID-3”), sets an RFDB bit to instruct access terminals not to transmit registration requests (e.g., “RFDB=0”), sets the PhysicalChannelCount to either 1 or 2, and lists IM_2 (e.g., if PhysicalChannelCount=1), or both IM_1 and IM_2 (e.g., if PhysicalChannelCount=2) as carrying the advertised BCMCS flow. An access terminal within the boundary sector B1 receives the BOM and tunes to IM_2, or both IM_1 and IM_2, 1305, depending on of the number of IM pairs advertised in the BOM.

Referring to FIG. 13, in 1310, the RAN 120 transmits multicast packet associated with the advertised BCMCS flow on IM_1 of the downlink BCH in boundary sector B1 at a first data rate (e.g., 307.2 kbps). In 1315, the RAN 120 transmits multicast packet associated with the advertised BCMCS flow on IM_2 of the downlink BCH in boundary sector B1 at a second data rate (e.g., 76.8 kbps). In 1320, the AT decodes the multicast packets based at least upon IM_2 (e.g., both IM_1 and IM_2 if PhysicalChannelCount =2, or only IM_2 if PhysicalChannelCount=1).

As will be appreciated by one of ordinary skill in the art, the access terminal in 1320 has a better chance of decoding the multicast packets based on both IM_1 and IM_2 transmissions because a successful decoding of either of the IM pairs means the AT can successfully decode a multicast packet. This decoding benefit is achieved at the expense of extra resources being allocated for the supplemental IM pair on the downlink BCH.

Further, above-described embodiments have been described wherein a supplemental channel on the downlink BCH is configured to carry multicast packets so as to aid access terminals in decoding multicast packets sent on a primary channel on the downlink BCH. The supplemental channel is used in boundary sectors that are adjacent to sectors belonging to a different subnet than the boundary sector. The supplemental channel permits access terminals in the boundary sector to better decode packets associated with the multicast session.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., access terminal). In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

While the foregoing disclosure shows illustrative embodiments of the invention, it should be noted that various changes and modifications could be made herein without departing from the scope of the invention as defined by the appended claims. The functions, steps and/or actions of the method claims in accordance with the embodiments of the invention described herein need not be performed in any particular order. Furthermore, although elements of the invention may be described or claimed in the singular, the plural is contemplated unless limitation to the singular is explicitly stated.

What is claimed is:

1. A method of supporting multicast communications at boundary sectors within a wireless communications system, comprising:
configuring a primary cluster for a given multicast session, the primary cluster including a plurality of sectors within a first subnet;
configuring a boundary cluster for the multicast session, the boundary cluster including at least one boundary sector that overlaps with a sector belonging to the primary cluster, the boundary sector being adjacent to a sector belonging to a second subnet;
transmitting multicast packets associated with the given multicast session at each of the plurality of sectors of the primary cluster on a primary channel at a first data rate; and
transmitting multicast packets associated with the given multicast session at the at least one boundary sector on a supplemental channel at a second data rate.

2. The method of claim 1, wherein the first data rate is greater than the second data rate.

3. The method of claim 1, wherein the transmitting steps transmit the multicast packets on a downlink broadcast channel (BCH).

4. The method of claim 1, further comprising:
transmitting a message advertising the given multicast session and indicating one or more channels on a downlink broadcast channel (BCH) upon which the given multicast session is being carried.

5. The method of claim 4, wherein the message indicates the primary channel and not the supplemental channel within sectors of the primary cluster that do not belong to the boundary cluster.

6. The method of claim 4, wherein the message indicates at least the supplemental channel within the at least one boundary sector of the boundary cluster.

7. The method of claim 6, wherein the message advertises the primary channel and the supplemental channel within the at least one boundary sector of the boundary cluster.

8. The method of claim 6, wherein the message advertises the supplemental channel and not the primary channel within the at least one boundary sector of the boundary cluster.

9. The method of claim 4, wherein the transmitted message is a broadcast overhead message (BOM) that lists an interlace-multiplex (IM) pair on the downlink BCH for the one or more channels.

10. The method of claim 1, wherein the boundary cluster includes a first boundary sector adjacent to the second subnet and a second boundary sector adjacent to a third subnet.

11. The method of claim 1, wherein the only subnet to which the at least one boundary sector of the boundary cluster is adjacent is the second subnet.

12. The method of claim 1, wherein the plurality of sectors of the primary cluster includes at least one target sector and at least one supporting sector, the at least one target sector including one or more access terminals that have registered to the given multicast session and the at least one supporting sector not including access terminals that have registered to the given multicast session.

13. The method of claim 12, wherein sectors belonging to the boundary cluster correspond only to target sectors of the primary cluster.

14. A method of monitoring multicast communications at boundary sectors within a wireless communications system, comprising:
receiving a message at an access terminal located within a boundary sector that belongs to a first subnet and is adjacent to at least one sector belonging to a second subnet, the received message advertising a given multicast session and indicating one or more channels on a downlink upon which the given multicast session is being carried;
tuning to the one or more channels on the downlink to monitor for multicast packets associated with the given multicast session;
receiving multicast packets associated with the given multicast session on multiple channels, the multiple channels including the one or more channels on the downlink indicated by the received message; and
decoding the received multicast packets on the one or more channels on the downlink.

15. The method of claim 15, wherein the multiple channels from which the multicast packets are received includes a primary channel transmitting at a first data rate and a supplemental channel transmitting at a second data rate.

16. The method of claim 15, further comprising:
receiving a transmission of the multicast packets on the supplemental channel from one or more other boundary sectors,
wherein the decoding step decodes the multicast packets on the supplemental channel of the boundary sector by soft-combining the multicast packets received on the supplemental channel from the one or more other boundary sectors.

17. The method of claim 15, wherein the first data rate is greater than the second data rate.

18. The method of claim 15, wherein the received message only indicates the supplemental channel.

19. The method of claim 18, wherein the decoding step only decodes the received multicast packets on the supplemental channel.

20. The method of claim 15, wherein the received message indicates both the supplemental channel and the primary channel.

21. The method of claim 20, wherein the decoding step decodes the received multicast packets on the supplemental channel and the primary channel.

22. The method of claim 14, wherein the multicast packets are received on a downlink broadcast channel (BCH).

23. The method of claim 22, wherein the received message is a broadcast overhead message (BOM) that lists an interlace-multiplex (IM) pair on the downlink BCH for the one or more channels.

24. The method of claim 14, wherein the boundary sector qualifies as a target sector, where target sectors include one or more access terminals that have registered to the given multicast session.

25. An access network within a wireless communications system, comprising:
means for configuring a primary cluster for a given multicast session, the primary cluster including a plurality of sectors within a first subnet;
means for configuring a boundary cluster for the multicast session, the boundary cluster including at least one boundary sector that overlaps with a sector belonging to the primary cluster, the boundary sector being adjacent to a sector belonging to a second subnet;
means for transmitting multicast packets associated with the given multicast session at each of the plurality of sectors of the primary cluster on a primary channel at a first data rate; and
means for transmitting multicast packets associated with the given multicast session at the at least one boundary sector on a supplemental channel at a second data rate.

26. The access network of claim 25, further comprising:
means for transmitting a message advertising the given multicast session and indicating one or more channels on a downlink broadcast channel (BCH) upon which the given multicast session is being carried.

27. An access terminal within a wireless communications system, comprising:
means for receiving a message within a boundary sector that belongs to a first subnet and is adjacent to at least one sector belonging to a second subnet, the received message advertising a given multicast session and indicating one or more channels on a downlink upon which the given multicast session is being carried;
means for tuning to the one or more channels on the downlink to monitor for multicast packets associated with the given multicast session;
means for receiving multicast packets associated with the given multicast session on multiple channels, the multiple channels including the one or more channels on the downlink indicated by the received message; and
means for decoding the received multicast packets on the one or more channels on the downlink.

28. The access terminal of claim 27, wherein the multiple channels from which the multicast packets are received includes a primary channel transmitting at a first data rate and a supplemental channel transmitting at a second data rate.

29. An access network within a wireless communications system, comprising:
logic configured to configure a primary cluster for a given multicast session, the primary cluster including a plurality of sectors within a first subnet;
logic configured to configure a boundary cluster for the multicast session, the boundary cluster including at least one boundary sector that overlaps with a sector belonging to the primary cluster, the boundary sector being adjacent to a sector belonging to a second subnet;
logic configured to transmit multicast packets associated with the given multicast session at each of the plurality of sectors of the primary cluster on a primary channel at a first data rate; and
logic configured to transmit multicast packets associated with the given multicast session at the at least one boundary sector on a supplemental channel at a second data rate.

30. The access network of claim 29, further comprising:
logic configured to transmit a message advertising the given multicast session and indicating one or more channels on a downlink broadcast channel (BCH) upon which the given multicast session is being carried.

31. An access terminal within a wireless communications system, comprising:
logic configured to receive a message within a boundary sector that belongs to a first subnet and is adjacent to at least one sector belonging to a second subnet, the received message advertising a given multicast session and indicating one or more channels on a downlink upon which the given multicast session is being carried;
logic configured to tune to the one or more channels on the downlink to monitor for multicast packets associated with the given multicast session;
logic configured to receive multicast packets associated with the given multicast session on multiple channels, the multiple channels including the one or more channels on the downlink indicated by the received message; and
logic configured to decode the received multicast packets on the one or more channels on the downlink.

32. The access terminal of claim 31, wherein the multiple channels from which the multicast packets are received includes a primary channel transmitting at a first data rate and a supplemental channel transmitting at a second data rate.

33. A computer-readable medium comprising instructions, which, when executed by an access network within a wireless communications system, cause the access network to perform operations, the instructions comprising:
program code to configure a primary cluster for a given multicast session, the primary cluster including a plurality of sectors within a first subnet;
program code to configure a boundary cluster for the multicast session, the boundary cluster including at least one boundary sector that overlaps with a sector belonging to the primary cluster, the boundary sector being adjacent to a sector belonging to a second subnet;
program code to transmit multicast packets associated with the given multicast session at each of the plurality of sectors of the primary cluster on a primary channel at a first data rate; and
program code to transmit multicast packets associated with the given multicast session at the at least one boundary sector on a supplemental channel at a second data rate.

34. The access network of claim 33, further comprising:
program code to transmit a message advertising the given multicast session and indicating one or more channels on a downlink broadcast channel (BCH) upon which the given multicast session is being carried.

35. A computer-readable medium comprising instructions, which, when executed by an access terminal within a wireless communications system, cause the access terminal to perform operations, the instructions comprising:
program code to receive a message within a boundary sector that belongs to a first subnet and is adjacent to at least one sector belonging to a second subnet, the received message advertising a given multicast session and indicating one or more channels on a downlink upon which the given multicast session is being carried;
program code to tune to the one or more channels on the downlink to monitor for multicast packets associated with the given multicast session;
program code to receive multicast packets associated with the given multicast session on multiple channels, the multiple channels including the one or more channels on the downlink indicated by the received message; and
program code to decode the received multicast packets on the one or more channels on the downlink.

36. The computer-readable medium of claim 35, wherein the multiple channels from which the multicast packets are received includes a primary channel transmitting at a first data rate and a supplemental channel transmitting at a second data rate.
